(19) United States
(12) Patent Application Publication
(10) Pub. No.: US 2025/0138227 A1
(43) Pub. Date: May 1, 2025

(54) OPTICAL ELEMENT

(71) Applicant: FUJIFILM Corporation, Tokyo (JP)

(72) Inventors: Yukito SAITOH, Minamiashigara-shi (JP); Yujiro YANAI, Minamiashigara-shi (JP); Kazuya HISANAGA, Minamiashigara-shi (JP)

(73) Assignee: FUJIFILM Corporation, Tokyo (JP)

(21) Appl. No.: 19/008,361

(22) Filed: Jan. 2, 2025

Related U.S. Application Data
(63) Continuation of application No. PCT/JP2023/029708, filed on Aug. 17, 2023.

(30) Foreign Application Priority Data
Aug. 18, 2022 (JP) 2022-130696

(51) Int. Cl. G02B 5/18

(52) U.S. Cl. CPC G02B 5/18

(57) ABSTRACT

An object of the present invention to provide an optical element which can improve utilization efficiency of spectrally separated light. The object is achieved by including a liquid crystal diffraction element and a prism having a first surface which is in direct contact with the liquid crystal diffraction element or is in contact with the liquid crystal diffraction element through another layer, in which the liquid crystal diffraction element includes an optically anisotropic layer having a liquid crystal alignment pattern in which an orientation of an optical axis derived from a liquid crystal compound changes while continuously rotating in at least one in-plane direction, and the prism has a second surface which reflects one of separated light by diffraction of the liquid crystal diffraction element.

### CROSS-REFERENCE TO RELATED APPLICATIONS

This application is a Continuation of PCT International Application No. PCT/JP2023/029708 filed on Aug. 17, 2023, which claims priority under 35 U.S.C. § 119(a) to Japanese Patent Application No. 2022-130696 filed on Aug. 18, 2022. The above applications are hereby expressly incorporated by reference, in their entirety, into the present application.

### BACKGROUND OF THE INVENTION

### 1. Field of the Invention

The present invention relates to an optical element which spectrally separates incidence ray using a liquid crystal diffraction element.

### 2. Description of the Related Art

A liquid crystal diffraction element which diffracts incidence ray and allows transmission of the diffracted light has been known.

As the liquid crystal diffraction element, a liquid crystal diffraction element including an optically anisotropic layer which is formed of a liquid crystal composition containing a liquid crystal compound has been known.

For example, JP2017-522601A discloses a liquid crystal diffraction element (optical element) including a plurality of laminated birefringent sub-layers such as a liquid crystal sub-layer, configured to change a propagation direction of light passing through the liquid crystal sub-layer according to a Bragg condition, in which the laminated birefringent sub-layers include local optical axes which change along respective boundary surfaces between adjacent laminated birefringent sub-layers to define respective lattice periods.

In the liquid crystal diffraction element, as shown in FIG. 2 and the like of JP2017-522601A, a birefringent sub-layer constituting the laminated birefringent sub-layer has an alignment pattern of a liquid crystal compound in which an orientation of a rod-like liquid crystal compound, that is, an orientation of an optical axis derived from the liquid crystal compound continuously rotates in one direction.

A liquid crystal diffraction element having an alignment pattern (liquid crystal alignment pattern) of a liquid crystal compound, as disclosed in JP2017-522601A, can diffract (refract) incident light at an angle depending on a wavelength. In addition, in a case of light having the same wavelength, the light can be diffracted at a certain angle.

The liquid crystal diffraction element having the liquid crystal alignment pattern can be used for various applications using such characteristics. For example, the liquid crystal diffraction element can be suitably used as a spectral element in a hyperspectral camera which images light by spectrally separating incidence ray into a plurality of wavelength ranges.

### SUMMARY OF THE INVENTION

Such a liquid crystal diffraction element can diffract and spectrally separate incidence ray.

On the other hand, the liquid crystal diffraction element diffracts incidence ray to be separated into two different directions depending on polarization. Therefore, in a device such as a hyperspectral camera which uses the liquid crystal diffraction element as a spectral element, it is difficult to use all of the spectrally separated light, that is, there is a problem in that utilization efficiency of the spectrally separated light is low.

An object of the present invention is to solve the above-described problem of the related art, and to provide an optical element which spectrally separates incidence ray using a liquid crystal diffraction element, in which utilization efficiency of spectrally separated light can be improved.

In order to solve the problem, the optical element according to an aspect of the present invention has the following configuration.

[1] An optical element comprising:
a liquid crystal diffraction element; and
a prism having a first surface which is in direct contact with the liquid crystal diffraction element or is in contact with the liquid crystal diffraction element through another layer,
in which the liquid crystal diffraction element includes an optically anisotropic layer having a liquid crystal alignment pattern in which an orientation of an optical axis derived from a liquid crystal compound changes while continuously rotating in at least one in-plane direction, and
the prism has a second surface which reflects one of separated light by diffraction of the liquid crystal diffraction element.

[2] The optical element according to [1],
in which, in the optically anisotropic layer, the liquid crystal compound is helically twisted and aligned along a thickness direction.

[3] The optical element according to [1] or [2],
in which the liquid crystal diffraction element includes at least two optically anisotropic layers in which the liquid crystal compound is helically twisted and aligned along a thickness direction, and
twisted directions of the liquid crystal compound in two of the optically anisotropic layers are opposite to each other in the thickness direction.

[4] The optical element according to any one of [1] to [3],
in which an angle between the first surface and the second surface of the prism is 70° to 110°.

[5] The optical element according to any one of [1] to [4],
in which light separated by the diffraction of the liquid crystal diffraction element and reflected by the second surface and light which is not incident into the second surface are emitted from the same surface of the prism.

With the optical element according to the aspect of the present invention, which spectrally separates incidence ray using a liquid crystal diffraction element, utilization efficiency of spectrally separated light can be improved.

### BRIEF DESCRIPTION OF THE DRAWINGS

FIG. 1 is a view conceptually showing an example of the optical element according to the embodiment of the present invention.

FIG. 2 is a view conceptually showing an example of a liquid crystal diffraction element.

FIG. 3 is a plan view showing an optically anisotropic layer of the liquid crystal diffraction element shown in FIG. 2.

FIG. 4 is a conceptual view showing an action of the optically anisotropic layer of the liquid crystal diffraction element shown in FIG. 2.

FIG. 5 is a conceptual view showing an action of the optically anisotropic layer of the liquid crystal diffraction element shown in FIG. 2.

FIG. 6 is a view conceptually showing another example of the liquid crystal diffraction element.

FIG. 7 is a view conceptually showing an example of an exposure device which exposes an alignment film of the liquid crystal diffraction element shown in FIG. 2.

FIG. 8 is a view conceptually showing an action of a liquid crystal diffraction element.

FIG. 9 is a view conceptually showing an example of a spectral element using the optical element according to the embodiment of the present invention.

FIG. 10 is a view conceptually showing another example of the optical element according to the embodiment of the present invention.

FIG. 11 is a view conceptually showing an example of a spectral element using the optical element according to the embodiment of the present invention.

FIG. 12 is a view conceptually showing still another example of the optical element according to the embodiment of the present invention.

FIG. 13 is a conceptual view for describing Examples of the present invention.

FIG. 14 is a conceptual view for describing Examples of the present invention.

### DESCRIPTION OF THE PREFERRED EMBODIMENTS

Hereinafter, the optical element according to the embodiment of the present invention will be described in detail based on suitable embodiments shown in the accompanying drawings.

In the present specification, a numerical range represented by “to” means a range including numerical values before and after “to” as a lower limit value and an upper limit value.

In the present specification, “(meth)acrylate” is used to mean “either or both of acrylate and methacrylate”.

In the present specification, “same” includes an error range generally accepted in the technical field. In addition, in the present specification, the meaning of “all”, “entire”, or “entire surface” includes not only 100% but also a case in which an error range is generally allowable in the technical field, for example, 99% or more, 95% or more, or 90% or more.

In the present specification, visible light is light having a wavelength which can be seen by human eyes among electromagnetic waves, and refers to light in a wavelength range of 380 to 780 nm. Non-visible light refers to light in a wavelength range of less than 380 nm or more than 780 nm.

In addition, although not limited thereto, among the visible light, light in a wavelength range of 420 to 490 nm is blue light, light in a wavelength range of 495 to 570 nm is green light, and light in a wavelength range of 620 to 750 nm is red light. Furthermore, although not limited thereto, among the non-visible light, ultraviolet ray (ultraviolet light) is light in a wavelength range of less than 380 nm and 200 nm or more, and infrared ray (infrared light) is light in a wavelength range of more than 780 nm and 12,000 nm or less.

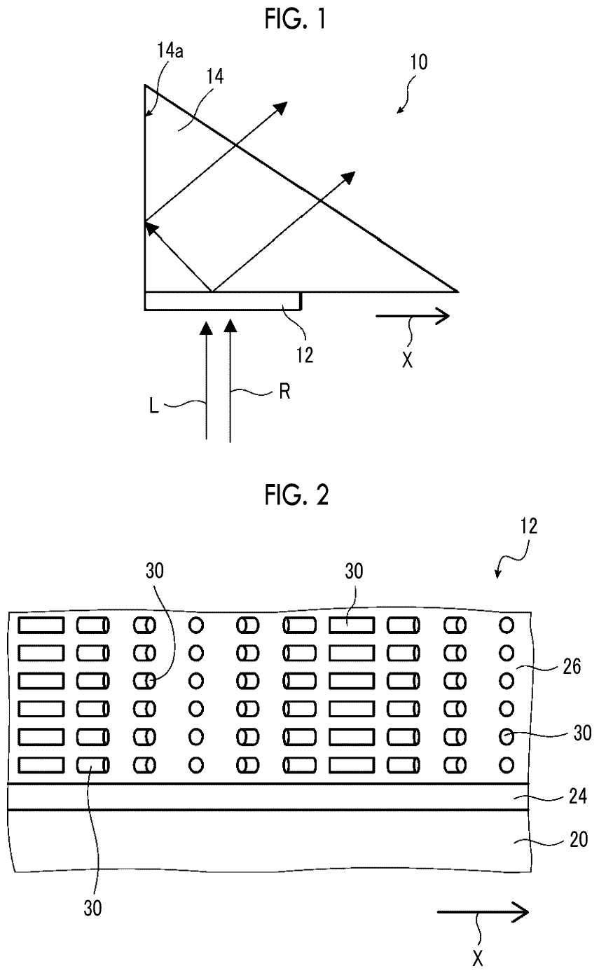

FIG. 1 is a view conceptually showing an example of the optical element according to the embodiment of the present invention.

An optical element 10 shown in FIG. 1 includes a liquid crystal diffraction element 12 and a prism 14.

Although described below in detail, the liquid crystal diffraction element 12 includes an optically anisotropic layer (reference numeral 26 in FIG. 2). The optically anisotropic layer has a liquid crystal alignment pattern in which an orientation of an optical axis derived from a liquid crystal compound changes while continuously rotating in at least one in-plane direction.

In a case where unpolarized ray is incident, the optically anisotropic layer having the above-described liquid crystal alignment pattern, that is, the liquid crystal diffraction element 12 including the optically anisotropic layer spectrally separates the incidence ray depending on a wavelength and diffracts dextrorotatory circularly polarized light R (dextrorotatory circularly polarized light component R) and levorotatory circularly polarized light L (levorotatory circularly polarized light component L) in opposite directions.

In other words, the liquid crystal diffraction element 12 (optically anisotropic layer) diffracts incident unpolarized ray to separate the unpolarized ray into dextrorotatory circularly polarized light and levorotatory circularly polarized light, and diffract (refract) the light in opposite directions.

In the optical element 10 according to the embodiment of the present invention, the liquid crystal diffraction element 12 is disposed on one surface of the prism 14. The surface on which the liquid crystal diffraction element 12 is disposed is a first surface in the present invention.

For example, as shown in FIG. 1, the liquid crystal diffraction element 12 diffracts dextrorotatory circularly polarized light R in a right direction in the drawing and levorotatory circularly polarized light L in a left direction in the drawing, from incident unpolarized ray.

The light diffracted and separated by the liquid crystal diffraction element 12 (optically anisotropic layer) in the left direction is reflected from a second surface 14a of the prism 14.

The light (dextrorotatory circularly polarized light) diffracted by the liquid crystal diffraction element 12 in the right direction and the light reflected by the second surface 14a of the prism 14 are converted into parallel light, and emitted from the same surface of the prism 14 in the same direction. The light reflected by the second surface 14a of the prism 14 is converted into levorotatory circularly polarized light by the reflection.

Accordingly, with the present invention, the light which is spectrally separated by the liquid crystal diffraction element can be used with high utilization efficiency. The above point will be described later.

FIG. 2 conceptually shows an example of the liquid crystal diffraction element.

The liquid crystal diffraction element 12 in the illustrated example includes a support 20, an alignment film 24, and an optically anisotropic layer 26.

In the liquid crystal diffraction element 12, the optically anisotropic layer 26 is formed of a composition containing a liquid crystal compound 30. In the present invention, the optically anisotropic layer 26 has a predetermined liquid crystal alignment pattern in which an orientation of an optical axis derived from the liquid crystal compound 30 continuously changes while rotating in at least one direction.

The liquid crystal diffraction element 12 in the illustrated example includes the support 20, but the liquid crystal diffraction element may not include the support 20. For example, based on the configuration shown in FIG. 2, the support 20 may be peeled off from the liquid crystal diffraction element so that the optically anisotropic layer is configured of only the alignment film 24 and the optically anisotropic layer 26. Furthermore, based on the configuration shown in FIG. 2, the support 20 and the alignment film 24 may be peeled off from the liquid crystal diffraction element so that the liquid crystal diffraction element is configured of only the optically anisotropic layer 26.

Alternatively, the first surface of the prism 14 described later may act as the support.

That is, in the optical element 10 according to the embodiment of the present invention, various layer configurations can be used as long as the liquid crystal diffraction element 12 includes the optically anisotropic layer formed of a composition containing a liquid crystal compound and the optically anisotropic layer has a liquid crystal alignment pattern in which an orientation of an optical axis derived from the liquid crystal compound changes while continuously rotating in at least one in-plane direction.

As described above, the liquid crystal diffraction element 12 includes the support 20, the alignment film 24, and the optically anisotropic layer 26.

In the liquid crystal diffraction element 12, the support 20 supports the alignment film 24 and the optically anisotropic layer 26.

As the support 20, various sheet-like materials (films, plate-like materials, and layers) can be used as long as they can support the alignment film 24 and the optically anisotropic layer 26 and have sufficient transparency to light having a wavelength to be subjected to spectroscopy. In addition, the support may have flexibility or may not have flexibility.

As the support, for example, a polyacrylic resin film such as polymethyl methacrylate, a cellulose-based resin film such as cellulose triacetate, a cycloolefin polymer-based film, a resin film such as polyethylene terephthalate (PET), polycarbonate, and polyvinyl chloride, a glass plate, or the like can be used. Examples of the cycloolefin polymer-based film include “ARTON” (trade name) manufactured by JSR Corporation and “ZEONOR” (trade name) manufactured by Nippon Zeon Corporation.

A thickness of the support 20 is not particularly limited and may be appropriately set depending on the use of the liquid crystal diffraction element 12, a material for forming the support 20, and the like in a range in which the alignment film 24 and the optically anisotropic layer 26 can be supported.

An additive such as an ultraviolet absorber may be added to the support 20. It is preferable that an ultraviolet absorber is added to the support 20 from the viewpoint of improving light fastness of the liquid crystal diffraction element 12.

In the liquid crystal diffraction element 12, the alignment film 24 is formed on a surface of the support 20.

The alignment film 24 is an alignment film for aligning the liquid crystal compound 30 to the predetermined liquid crystal alignment pattern during the formation of the optically anisotropic layer 26 of the liquid crystal diffraction element 12.

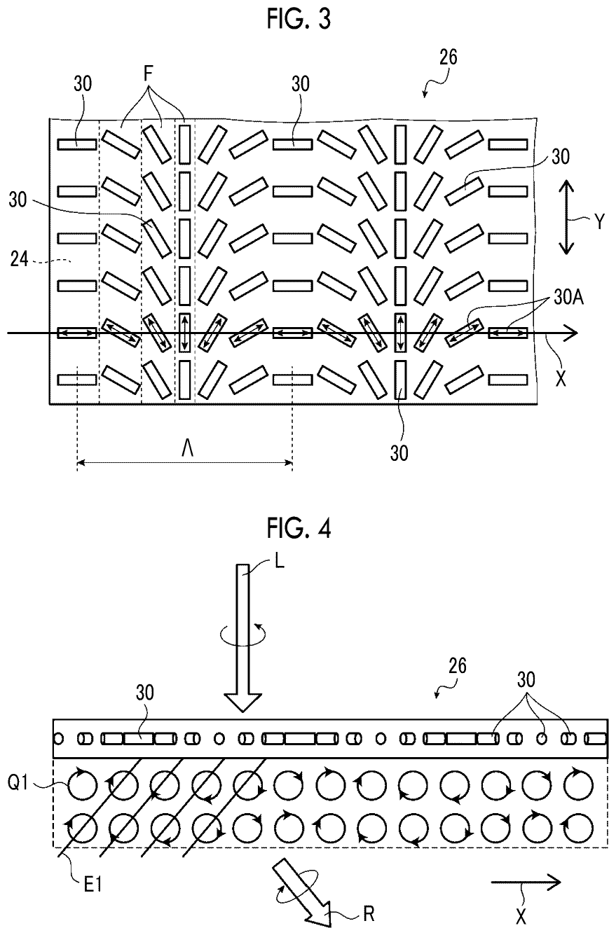

As described later, in the liquid crystal diffraction element 12, the optically anisotropic layer 26 has a liquid crystal alignment pattern in which an orientation of an optical axis 30A (see FIG. 3) derived from the liquid crystal compound 30 changes while continuously rotating in one in-plane direction (arrow X direction described later). Accordingly, the alignment film 24 of the liquid crystal diffraction element 12 is formed such that the optically anisotropic layer 26 can form the liquid crystal alignment pattern.

In the following description, “orientation of the optical axis 30A rotates” will also be simply referred to as “optical axis 30A rotates”.

As the alignment film 24, various known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, or methyl stearate.

The alignment film formed by a rubbing treatment can be formed by rubbing a surface of a polymer layer with paper or fabric in a given direction multiple times.

Preferred examples of the material used for the alignment film include a material for forming polyimide, polyvinyl alcohol, a polymer having a polymerizable group described in JP1997-152509A (JP-H9-152509A), and an alignment film described in JP2005-97377A, JP2005-99228A, and JP2005-128503A.

In the liquid crystal diffraction element 12, for example, the alignment film 24 can be suitably used as a so-called photo-alignment film obtained by irradiating a photo-alignment material with polarized light or non-polarized light. That is, in the liquid crystal diffraction element 12, a photo-alignment film which is formed by applying a photo-alignment material onto the support 20 is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the photo-alignment film which can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide-and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitability used.

A thickness of the alignment film 24 is not particularly limited. The thickness with which a required alignment function can be obtained may be appropriately set depending on the material for forming the alignment film 24. The thickness of the alignment film 24 is preferably 0.01 to 5 μm and more preferably 0.05 to 2 μm.

A method for forming the alignment film is not limited, and various known methods can be used depending on the material for forming the alignment film. Examples thereof include a method including: applying the alignment film to a surface of the support 20; drying the applied alignment film; and exposing the alignment film to laser light to form an alignment pattern.

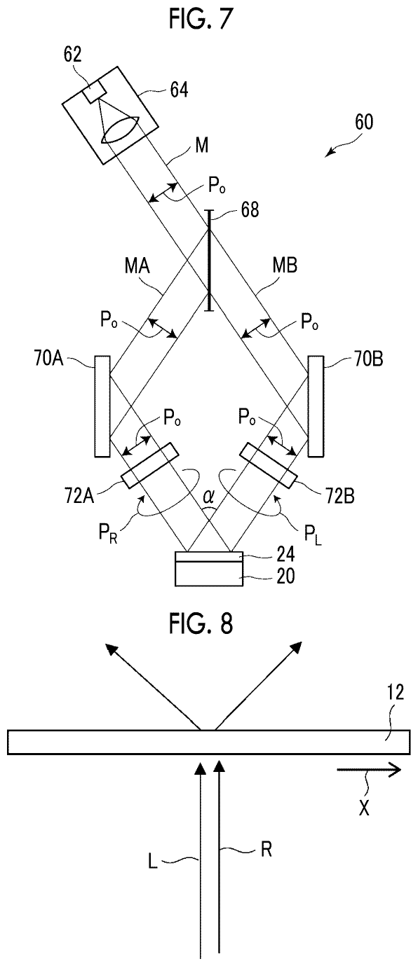

FIG. 7 conceptually shows an example of an exposure device which exposes the alignment film 24 to form the above-described alignment pattern.

An exposure device 60 shown in FIG. 7 includes a light source 64 including a laser 62, a beam splitter 68 which separates a laser light M emitted from the laser 62 into two rays of a ray MA and a ray MB, mirrors 70A and 70B respectively disposed on optical paths of the two separated rays MA and MA, and λ/4 plates 72A and 72B.

Although not shown, the light source 64 emits linearly polarized light P₀. The λ/4 plate 72A converts the linearly polarized light P₀ (ray MA) into dextrorotatory circularly polarized light P_{R}, and the λ/4 plate 72B converts the linearly polarized light P₀ (ray MB) into levorotatory circularly polarized light P_{L}.

The support 20 including the alignment film 24 on which the alignment pattern is not yet formed is disposed at an exposed portion, the two rays MA and MB intersect and interfere each other on the alignment film 24, and the alignment film 24 is irradiated with and exposed to the interference light.

Due to the interference at this time, the polarization state of light with which the alignment film 24 is irradiated periodically changes according to interference fringes. As a result, in the alignment film 24, an alignment pattern in which the alignment state periodically changes can be obtained.

In the exposure device 60, by changing an intersecting angle α between the two rays MA and MB, a period of the alignment pattern can be adjusted. That is, by adjusting the intersecting angle α in the exposure device 60, in the alignment pattern in which an optical axis 30A derived from the liquid crystal compound 30 continuously rotates in one direction, a length of single period (single period Λ described later) over which the optical axis 30A rotates 180° in the one direction of the rotated optical axis 30A can be adjusted.

By forming the optically anisotropic layer on the alignment film having the alignment pattern in which the alignment state periodically changes, as described below, the optically anisotropic layer 26 having the liquid crystal alignment pattern in which the optical axis 30A derived from the liquid crystal compound 30 continuously rotates in the one direction can be formed.

In addition, by rotating the optical axes of the λ/4 plates 72A and 72B by 90°, respectively, the rotation direction of the optical axis 30A can be reversed.

In the liquid crystal diffraction element, the alignment film is provided as a preferred aspect, and is not an essential configuration requirement.

For example, the following configuration can also be adopted, in which, by forming the alignment pattern on the support 20 using a method of rubbing the support 20, a method of processing the support 20 with laser light or the like, or the like, the optically anisotropic layer 26 and the like have the liquid crystal alignment pattern in which the orientation of the optical axis 30A derived from the liquid crystal compound 30 changes rotationally in at least one in-plane direction.

In the liquid crystal diffraction element 12, the optically anisotropic layer 26 is formed on a surface of the alignment film 24.

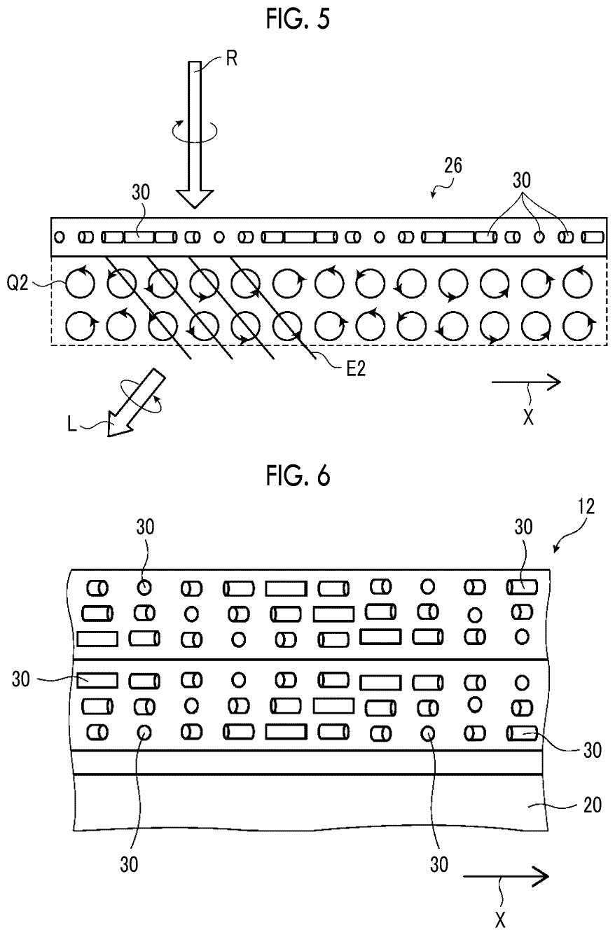

In order to simplify the drawing to clarify the configuration of the liquid crystal diffraction element 12 in FIGS. 4 and 5 described later, only the liquid crystal compound 30 (liquid crystal compound molecule) on the surface of the alignment film in the optically anisotropic layer 26 is shown. However, as conceptually shown in FIG. 2, the optically anisotropic layer 26 has a structure in which the aligned liquid crystal compounds 30 are stacked in the thickness direction, similarly to the optically anisotropic layer formed of a composition containing a typical liquid crystal compound.

As described above, in the liquid crystal diffraction element 12, the optically anisotropic layer (liquid crystal layer) 26 is formed of a composition containing a liquid crystal compound. In a case where a value of an in-plane retardation is set as λ/2, the optically anisotropic layer 26 has a function as a general λ/2 plate, that is, a function of imparting a phase difference of a half wavelength, that is, 180° to two linearly polarized light components which are included in light incident into the optically anisotropic layer and are orthogonal to each other.

The optically anisotropic layer 26 has a liquid crystal alignment pattern in which the orientation of the optical axis 30A derived from the liquid crystal compound 30 changes while continuously rotating in one in-plane direction indicated by the arrow X.

The optical axis 30A derived from the liquid crystal compound 30 is an axis having the highest refractive index in the liquid crystal compound 30, that is, a so-called slow axis. For example, in a case where the liquid crystal compound 30 is a rod-like liquid crystal compound, the optical axis 30A is along a major axis direction of the rod shape.

In the following description, “one direction indicated by the arrow X” will also be simply referred to as “arrow X direction”. In addition, in the following description, the optical axis 30A derived from the liquid crystal compound 30 will also be referred to as “optical axis 30A of the liquid crystal compound 30” or “optical axis 30A”.

In the optically anisotropic layer 26, the liquid crystal compounds 30 are two-dimensionally arranged in a plane parallel to the arrow X direction and a Y direction orthogonal to the arrow X direction. In FIG. 2 and FIGS. 4 and 5 described later, the Y direction is a direction orthogonal to the paper plane.

FIG. 3 conceptually shows a plan view of the optically anisotropic layer 26.

The plan view is a view in a case where the liquid crystal diffraction element 12 is seen from the top in FIG. 2, that is, a view in a case where the liquid crystal diffraction element 12 is seen from the thickness direction (laminating direction of the respective layers (films)). In other words, the plan view is a view in a case where the optically anisotropic layer 26 is seen from a direction orthogonal to a main surface. The main surface is a maximum surface of a sheet-like material, and is usually both surfaces of the sheet-like material in the thickness direction.

In addition, in order to clarify the configuration of the liquid crystal diffraction element 12 in FIG. 3, only the liquid crystal compound 30 on the surface of the alignment film 24 is shown with regard to the optically anisotropic layer 26 as in FIG. 2. However, as described above, the optically anisotropic layer 26 has a structure in which the liquid crystal compounds 30 are stacked in the thickness direction from the liquid crystal compound 30 on the surface of the alignment film 24 as shown in FIG. 2.

The optically anisotropic layer 26 has a liquid crystal alignment pattern in which the orientation of the optical axis 30A derived from the liquid crystal compound 30 changes while continuously rotating in a plane along the arrow X direction.

Specifically, the “orientation of the optical axis 30A of the liquid crystal compound 30 changes while continuously rotating in the arrow X direction (predetermined one direction)” means that an angle between the optical axis 30A of the liquid crystal compound 30, which is arranged in the arrow X direction, and the arrow X direction varies depending on positions in the arrow X direction, and the angle between the optical axis 30A and the arrow X direction sequentially changes from θ to θ+180° or to θ−180° in the arrow X direction.

A difference between the angles of the optical axes 30A of the liquid crystal compounds 30 adjacent to each other in the arrow X direction is preferably 45° or less, more preferably 15° or less, and still more preferably less than 15°.

Meanwhile, regarding the liquid crystal compound 30 forming the optically anisotropic layer 26, the liquid crystal compounds 30 in which the orientations of the optical axes 30A are the same as one another are arranged at equal intervals in the Y direction orthogonal to the arrow X direction, that is, the Y direction orthogonal to one direction in which the optical axes 30A continuously rotate.

In other words, regarding the liquid crystal compound 30 forming the optically anisotropic layer 26, in the liquid crystal compounds 30 arranged in the Y direction, angles between the orientations of the optical axes 30A and the arrow X direction are the same.

In such a liquid crystal alignment pattern of the liquid crystal compounds 30 in the optically anisotropic layer 26, the length (distance) over which the optical axis 30A of the liquid crystal compound 30 rotates by 180° in the arrow X direction that the orientation of the optical axis 30A continuously change while continuously rotating in a plane is defined by a length Λ of single period in the liquid crystal alignment pattern. In the description below, the length Λ of single period is also referred to as a single period Λ. In other words, the single period Λ in the liquid crystal alignment pattern is defined as a distance from θ to θ+180° of the angle between the optical axis 30A of the liquid crystal compound 30 and the arrow X direction.

That is, in the arrow X direction, a distance between centers of two liquid crystal compounds 30 having the same angle with respect to the arrow X direction is set as the single period Λ. Specifically, as shown in FIG. 2, the distance between the centers of two liquid crystal compounds 30 in which the arrow X direction and the direction of the optical axis 30A coincide with each other in the arrow X direction is set as the single period Λ.

In the liquid crystal diffraction element 12, in the liquid crystal alignment pattern of the optically anisotropic layer, the single period Λ is repeated in the arrow X direction, that is, in the one direction in which the orientation of the optical axis 30A changes while continuously rotating.

As described above, in the optically anisotropic layer, the liquid crystal compounds arranged in the Y direction have the same angle between the optical axis 30A and the arrow X direction (one direction in which the orientation of the optical axis of the liquid crystal compound 30 rotates). A region where the liquid crystal compounds 30 in which the angles between the optical axes 30A and the arrow X direction are the same are arranged in the Y direction will be referred to as a region F.

In this case, it is preferable that an in-plane retardation (Re) value of each of the regions F is a half wavelength, that is, λ/2. The in-plane retardation is calculated from a product of a difference Δn in refractive index due to refractive index anisotropy of the region F and a thickness of the optically anisotropic layer. Here, the difference in refractive index due to the refractive index anisotropy of the region F in the optically anisotropic layer is defined by a difference between a refractive index of a direction of an in-plane slow axis of the region F and a refractive index of a direction orthogonal to the direction of the slow axis. That is, the difference Δn in refractive index due to the refractive index anisotropy of the region F is the same as a difference between a refractive index of the liquid crystal compound 30 in the direction of the optical axis 30A and a refractive index of the liquid crystal compound 30 in a direction perpendicular to the optical axis 30A in a plane of the region F. That is, the above-described difference Δn in refractive index is the same as the difference in refractive index of the liquid crystal compound.

In a case where circularly polarized light is incident into such an optically anisotropic layer 26, the light is diffracted (refracted) and a direction of the circularly polarized light is changed.

The action is conceptually shown in FIG. 4. In the optically anisotropic layer 26, a product of the difference in refractive index of the liquid crystal compound and the thickness of the optically anisotropic layer is set to 2/2.

As shown in FIG. 4, in a case where the value of the product of the difference in refractive index of the liquid crystal compound and the thickness of the optically anisotropic layer in the optically anisotropic layer 26 is set to λ/2 and levorotatory circularly polarized light L is incident into the optically anisotropic layer 26, the levorotatory circularly polarized light L transmits through the optically anisotropic layer 26 to be imparted with a retardation of 180°, and the transmitted light is converted into the dextrorotatory circularly polarized light R.

In addition, in a case where the levorotatory circularly polarized light L incident into the optically anisotropic layer 26 transmits through the optically anisotropic layer 26, an absolute phase thereof changes depending on the orientation of the optical axis 30A of each of the liquid crystal compounds 30. At this time, since the orientation of the optical axis 30A changes while rotating in the arrow X direction, an amount of change in absolute phase of the levorotatory circularly polarized light L varies depending on the orientation of the optical axis 30A. Furthermore, the liquid crystal alignment pattern formed in the optically anisotropic layer 26 is a pattern which is periodic in the arrow X direction. Therefore, as shown in FIG. 4, the levorotatory circularly polarized light L transmitted through the optically anisotropic layer 26 is imparted with an absolute phase Q1 which is periodic in the arrow X direction corresponding to the orientation of each optical axis 30A. As a result, an equiphase plane E1 which is tilted in a direction opposite to the arrow X direction is formed.

Therefore, the dextrorotatory circularly polarized light R transmitted through the optically anisotropic layer 26 is refracted to be tilted in a direction perpendicular to the equiphase plane E1, and travels in a direction different from a traveling direction of the levorotatory circularly polarized light L as incidence ray. In this way, the levorotatory circularly polarized light L incident into the optically anisotropic layer 26 is converted into the dextrorotatory circularly polarized light R which is tilted by a predetermined angle in the arrow X direction with respect to the incidence direction.

On the other hand, as conceptually shown in FIG. 5, in a case where the value of the product of the difference in refractive index of the liquid crystal compound and the thickness of the optically anisotropic layer in the optically anisotropic layer 26 is set to λ/2 and dextrorotatory circularly polarized light R is incident into the optically anisotropic layer 26, the dextrorotatory circularly polarized light R transmits through the optically anisotropic layer 26 to be imparted with a retardation of 180°, and the transmitted light is converted into the levorotatory circularly polarized light L.

In addition, in a case where the dextrorotatory circularly polarized light R transmits through the optically anisotropic layer 26, an absolute phase thereof changes depending on the orientation of the optical axis 30A of each of the liquid crystal compounds 30. At this time, since the orientation of the optical axis 30A changes while rotating in the arrow X direction, an amount of change in absolute phase of the dextrorotatory circularly polarized light R varies depending on the orientation of the optical axis 30A. Furthermore, the liquid crystal alignment pattern formed in the optically anisotropic layer 26 is a pattern which is periodic in the arrow X direction. Therefore, as shown in FIG. 5, the dextrorotatory circularly polarized light R transmitted through the optically anisotropic layer 26 is imparted with an absolute phase Q2 which is periodic in the arrow X direction corresponding to the orientation of each optical axis 30A.

Here, since the incidence ray is the dextrorotatory circularly polarized light R, the absolute phase Q2 which is periodic in the arrow X direction corresponding to the orientation of the optical axis 30A is opposite to the levorotatory circularly polarized light L shown in FIG. 4. As a result, in the dextrorotatory circularly polarized light R, an equiphase plane E2 tilted in the arrow X direction, which is opposite to that of the levorotatory circularly polarized light L, is formed.

Therefore, the dextrorotatory circularly polarized light R is refracted to be tilted in a direction perpendicular to the equiphase plane E2, and travels in a direction different from a traveling direction of the dextrorotatory circularly polarized light R. In this way, the dextrorotatory circularly polarized light R incident into the optically anisotropic layer 26 is converted into the levorotatory circularly polarized light L which is tilted by a predetermined angle in a direction opposite to the arrow X direction, with respect to the incidence direction.

Therefore, by reversing a rotation direction of the optical axis 30A of the liquid crystal compound 30 which rotates in the arrow X direction, a diffraction direction of the transmitted light can be reversed.

That is, in the example shown in FIGS. 2 to 5, the rotation direction of the optical axis 30A toward the arrow X direction is clockwise. On the other hand, in a case where the rotation direction of the optical axis 30A is counterclockwise, the dextrorotatory circularly polarized light R as transmitted light is refracted in a direction opposite to the arrow X direction in a case where the incidence light is the levorotatory circularly polarized light L, and the levorotatory circularly polarized light L as transmitted light is diffracted in the arrow X direction in a case where the incidence light is the dextrorotatory circularly polarized light R.

In the optically anisotropic layer 26, the value of the in-plane retardation of a plurality of regions F is preferably a half wavelength. In particular, it is preferable that “in-plane retardation Re(λ)=Δn_{λ}×d” of the plurality of regions F of the optically anisotropic layer 26 with respect to the incidence ray having a wavelength of λ nm is within a range defined by Expression (1). Here, Δn_{λ} is the difference in refractive index due to the refractive index anisotropy of the region F in a case where the wavelength of incidence ray is λ nm, and d represents the thickness of the optically anisotropic layer 26.

$$0.7 \times ( λ / 2 ) nm \leq Δ {n}_{λ} \times d \leq 1.3 \times ( λ / 2 ) nm \qquad ( 1 )$$

That is, in a case where the “in-plane retardation Re(λ)=Δn_{λ}×d” of the plurality of regions F of the optically anisotropic layer 26 satisfies Expression (1), a sufficient amount of circularly polarized light components of light which has been incident on the optically anisotropic layer 26 can be converted into circularly polarized light traveling in a direction tilted in a forward or backward direction with respect to the arrow X direction.

In the “in-plane retardation Re(2)=Δn_{λ}×d”, it is more preferable that “0.8×(λ/2) nm≤Δn_{λ}×d≤1.2×(λ/2) nm” is satisfied and still more preferable that “0.9×(λ/2) nm≤Δn_{λ}×d≤1.1×(λ/2) nm” is satisfied.

In addition, the value of the in-plane retardation of the plurality of regions F of the optically anisotropic layer 26 in a range outside the range of Expression (1) can also be used. Specifically, in a case where “Δn_{λ}×d<0.7×(λ/2) nm” or “1.3×(λ/2)<Δn_{λ}×d” is satisfied, light can be divided into light traveling in the same direction as the traveling direction of the incidence ray and light traveling in a direction different from the traveling direction of incidence ray. In a case where Δn_{λ}×d approaches 0 nm or 2 nm, the light component traveling in the same direction as the traveling direction of incidence ray increases, and the light component traveling in a direction different from the traveling direction of incidence ray decreases.

Here, by changing the single period Λ of the liquid crystal alignment pattern formed in the optically anisotropic layer 26, a diffraction angle of the transmitted light can be adjusted.

Specifically, as the single period Λ of the liquid crystal alignment pattern decreases, light transmitted through the liquid crystal compounds 30 adjacent to each other more strongly interfere with each other, so that the transmitted light can be more largely diffracted. That is, in a case where light is incident from a normal direction of the optically anisotropic layer 26, as the single period Λ of the liquid crystal alignment pattern decreases, the angle between the normal direction and the transmitted light (diffracted light) increases.

The normal direction is a direction orthogonal to a plane of a sheet-like material, such as the main surface.

In addition, in the optically anisotropic layer 26, as the wavelength of incidence ray is longer, the transmitted light can be largely diffracted. That is, in a case where light is incident from the normal direction of the optically anisotropic layer 26, the angle of the transmitted light (diffracted light) with respect to the normal direction increases as the wavelength of incidence ray increases.

Accordingly, the optically anisotropic layer 26 (liquid crystal diffraction element 12) can spectrally separate incidence ray depending on the wavelength. For example, in a case where white light is incident on the optically anisotropic layer 26 from the normal direction, the angle between the normal direction and the transmitted light is the largest for red light, the second largest for green light, and the smallest for blue light. Therefore, the white light can be spectrally separated into the red light, green light, and blue light.

That is, the diffraction angle of the optically anisotropic layer 26 (liquid crystal diffraction element 12) is determined by “Λ/λ” of the single period Λ and the wavelength λ of incidence ray.

Furthermore, in the diffraction by the optically anisotropic layer 26, in a case where the wavelengths are the same, the diffraction (refraction) angles are the same regardless of whether the incidence ray is the dextrorotatory circularly polarized light R or the levorotatory circularly polarized light L.

For example, in a case where unpolarized light having a wavelength of 550 nm is incident on the optically anisotropic layer 26 from the normal direction, an angle between the dextrorotatory circularly polarized light R to be transmitted and the normal direction and an angle between the levorotatory circularly polarized light L to be transmitted and the normal direction are equal to each other.

The optically anisotropic layer 26 is formed by curing a liquid crystal composition containing a rod-like liquid crystal compound or a disk-like liquid crystal compound, and has a liquid crystal alignment pattern in which optical axes of the rod-like liquid crystal compounds or the disk-like liquid crystal compounds are aligned as described above.

The optically anisotropic layer 26 consisting of a cured layer of the liquid crystal composition can be obtained by forming the alignment film 24 on the support 20, coating the alignment film 24 with the liquid crystal composition, and curing the liquid crystal composition. The optically anisotropic layer 26 functions as a so-called λ/2 plate, but in the present invention, an aspect in which a laminate integrally including the support 20 and the alignment film 24 functions as the λ/2 plate is included.

The liquid crystal composition for forming the optically anisotropic layer 26 contains a rod-like liquid crystal compound or a disk-like liquid crystal compound, and may further contain other components such as a leveling agent, an alignment control agent, a polymerization initiator, and an alignment assistant.

It is preferable that the optically anisotropic layer 26 has a wide band with respect to the wavelength of incidence ray and is formed of a liquid crystal material having a birefringence which is inversely dispersed.

In addition, it is also preferable that the optically anisotropic layer is made to have a substantially wide band with respect to the wavelength of incidence ray by imparting a twist component to the liquid crystal composition and/or laminating different phase difference plates. For example, in the optically anisotropic layer, a method of realizing a λ/2 plate having a wide-range pattern by laminating two liquid crystal layers having different twisted directions is described in, for example, JP2014-089476A and can be preferably used in the present invention.

### Rod-like Liquid Crystal Compound

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. In addition to the above-described low-molecular-weight liquid crystal molecules, a high-molecular-weight liquid crystal molecular can also be used.

It is preferable that the alignment of the rod-like liquid crystal compound is fixed by polymerization, and examples of the polymerizable rod-like liquid crystal compound include compounds described in Makromol. Chem., (1989), Vol. 190, p. 2255, Advanced Materials (1993), Vol. 5, p. 107, U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627A. Furthermore, as the rod-like liquid crystal compound, for example, compounds described in JP1999-513019A (JP-H11-513019A) and JP2007-279688A can also be preferably used.

### Disk-like Liquid Crystal Compound

As the disk-like liquid crystal compound, for example, compounds described in JP2007-108732A, JP2010-244038A, and the like can be preferably used.

In a case where a disk-like liquid crystal compound is used in the optically anisotropic layer, the liquid crystal compound 30 rises in the thickness direction in the optically anisotropic layer, and the optical axis 30A derived from the liquid crystal compound is defined as an axis perpendicular to a disc plane, that is, a so-called fast axis (see FIG. 25).

In the liquid crystal diffraction element 12, a film thickness of the optically anisotropic layer 26 is not particularly limited, and from the viewpoint of reducing the thickness of the liquid crystal diffraction element 12, it is preferably 20 μm or less, more preferably 15 μm or less, still more preferably 10 μm or less, and particularly preferably 5 μm or less.

In the liquid crystal diffraction element 12 shown in FIG. 2, the orientations of the optical axes 30A in the liquid crystal compounds 30 constituting the optically anisotropic layer 26 match in the thickness direction.

However, the present invention is not limited thereto, and in the optical element 10 according to the embodiment of the present invention, as conceptually shown in FIG. 6, it is preferable that the liquid crystal compound 30 constituting the optically anisotropic layer 26 is helically twisted and aligned along the thickness direction of the optically anisotropic layer 26.

In the optically anisotropic layer 26, by twisting and aligning the liquid crystal compound 30 in the thickness direction, diffraction efficiency of circularly polarized light by the liquid crystal diffraction element 12 can be improved.

Here, in a case where the liquid crystal compound 30 constituting the optically anisotropic layer 26 is helically twisted and aligned in the thickness direction, the diffraction efficiency is different with respect to the dextrorotatory circularly polarized light and the levorotatory circularly polarized light, depending on the helical twisted direction.

Therefore, in a case where the liquid crystal compound 30 constituting the optically anisotropic layer 26 is helically twisted and aligned along the thickness direction, it is preferable that two optically anisotropic layers 26 having different twisted directions of the liquid crystal compound are laminated as shown in FIG. 6.

With such a configuration, it is possible to improve the diffraction efficiencies of both dextrorotatory circularly polarized light and levorotatory circularly polarized light and to match the diffraction efficiencies of the dextrorotatory circularly polarized light and the levorotatory circularly polarized light.

The number of laminated optically anisotropic layers is not limited to 1 or 2, and may be 3 or more layers as necessary.

In the optical element 10 according to the embodiment of the present invention, a twisted angle of the liquid crystal compound 30 in the optically anisotropic layer 26 is not limited.

From the viewpoint of suitably improving the diffraction efficiency, the absolute value of the twisted angle of the liquid crystal compound 30 is preferably 5° to 360°, more preferably 10° to 320°, still more preferably 20° to 280°, and particularly preferably 30° to 250°, regardless of whether the twisted direction of the liquid crystal compound 30 is right-twisted or left-twisted (clockwise or counterclockwise).

The twisted angle of the liquid crystal compound 30 is a twisted angle from a lower surface to an upper surface of the optically anisotropic layer 26, in which the liquid crystal compound 30 is twisted and aligned in the thickness direction.

In the optical element 10 according to the embodiment of the present invention, the liquid crystal diffraction element 12 including the optically anisotropic layer 26 is disposed on one surface of the prism 14.

In a case where the liquid crystal diffraction element 12 includes the alignment film 24 and/or the support 20, the optically anisotropic layer 26 of the liquid crystal diffraction element 12 may be provided on the prism 14 side or on a side opposite to the prism 14. In addition, an antireflection film such as a dielectric multi-layer film and a moth-eye film may be provided on an interface with air.

For example, the liquid crystal diffraction element 12 may be provided in direct contact with the prism 14 by forming the alignment film 24 and the optically anisotropic layer 26 on one surface of the prism 14 as described above, using the prism 14 as the support 20 shown in FIG. 2. In addition, the liquid crystal diffraction element 12 may be provided in direct contact with one surface of the prism 14 by a method such as an alignment treatment, application of the liquid crystal composition, and polymerization.

Alternatively, the liquid crystal diffraction element 12 may be bonded to one surface of the prism 14 using a bonding agent such as an optical clear adhesive (OCA), an optically transparent double-sided tape, and an ultraviolet curable resin. In addition, the liquid crystal diffraction element 12 may be directly bonded to one surface of the prism 14 by performing a surface treatment for strengthening adhesive strength, such as plasma treatment. An antireflection film or the like may be provided between the prism 14 and the liquid crystal diffraction element 12 as necessary.

In the optical element 10 according to the embodiment of the present invention, in a case where the optical element includes the support 20 and the alignment film 24 and any layer is provided between the optically anisotropic layer 26 and the prism 14, it is preferable that this layer has a refractive index close to the refractive indices of the optically anisotropic layer 26 and the prism 14. That is, it is preferable that the optically anisotropic layer 26 and the prism 14 are optically closely attached to each other.

Specifically, in a case where any layer is provided between the optically anisotropic layer 26 and the prism 14, a difference in refractive index between this layer and the optically anisotropic layer 26 and the prism 14 is preferably ±0.5 or less and more preferably ±0.3 or less.

In the optical element 10 shown in FIG. 1, the prism 14 is a triangular prism having a right-angled triangular bottom surface.

The liquid crystal diffraction element 12 is disposed on a surface serving as a side which sandwiches a right angle in a right triangle. In the optical element 10 of the illustrated example, the surface on which the liquid crystal diffraction element 12 is disposed is a first surface in the present invention, and a surface which is a side forming a right angle with the first surface is a second surface which reflects light separated by the diffraction of the liquid crystal diffraction element 12. As described above, the light separated by the diffraction of the liquid crystal diffraction element 12 is dextrorotatory circularly polarized light or levorotatory circularly polarized light.

In the present invention, the prism is an optical member (optical element) formed of a material such as quartz glass and crystal, that is, a transparent medium; and is used for dispersing, refracting, total reflection, and birefringence.

In the present invention, the light includes not only visible light but also electromagnetic waves such as ultraviolet rays and infrared rays described above.

As described above, in a case where unpolarized ray is incident into the liquid crystal diffraction element 12 (optically anisotropic layer 26), as conceptually shown in FIG. 8, the incidence ray is separated by the diffraction of the liquid crystal diffraction element 12, a component of the dextrorotatory circularly polarized light R is diffracted in, for example, the arrow X direction (right direction in the drawing), and a component of the levorotatory circularly polarized light L is diffracted in a direction opposite to the arrow X direction (left direction in the drawing).

As described above, the transmitted light is diffracted by the liquid crystal diffraction element 12 such that a revolution direction of the transmitted light is opposite to that of the incidence ray.

The light separated by the liquid crystal diffraction element 12 and diffracted in the left direction in the drawing propagates in the prism 14, is incident into the second surface 14a of the prism 14 which is orthogonal to the first surface on which the liquid crystal diffraction element 12 is disposed, and is specularly reflected. The turning direction of circularly polarized light is reversed by the reflection.

Here, as described above, the diffraction angles of the liquid crystal diffraction element 12 are the same as each other as long as the wavelengths of light are the same.

Accordingly, the light (diffracted light) which is diffracted in the left direction in the drawing, is incident into the second surface 14a of the prism 14, which is orthogonal to the first surface, that is, the main surface of the liquid crystal diffraction element 12 (optically anisotropic layer 26), and is specularly reflected from the second surface 14a, and the light (diffracted light) which is diffracted in a direction opposite to the light incident into the second surface 14a by the optically anisotropic layer 26 are parallel light.

That is, the two light separated according to the turning direction of circularly polarized light by the liquid crystal diffraction element 12 are emitted as parallel light from a surface of the prism 14, other than the first surface and the second surface 14a. Hereinafter, the surface will be referred to as a third surface for convenience.

In FIGS. 1 and 8, in order to concisely show the action of the optical element 10, the light diffracted by the liquid crystal diffraction element 12 is shown as two separated light having the same wavelength. However, as described above, the incidence ray incident into the optical element 10 according to the embodiment of the present invention is spectrally separated by the liquid crystal diffraction element 12 into a plurality of components, and is diffracted at angles depending on wavelengths. However, in the optical element 10 according to the embodiment of the present invention, the incidence ray may be a ray having a short wavelength (monochromatic light).

In addition, in FIG. 1, the light emitted from the third surface of the prism 14 is shown to be transmitted straight through the third surface for convenience. However, in reality, the light emitted from the third surface is refracted and emitted at the interface between the third surface and the air layer depending on a difference in refractive index between a material for forming the prism 14 and air and depending on an incidence angle on the third surface. The same applies to other drawings for describing the optical element according to the embodiment of the present invention.

As shown in FIG. 8, the light diffracted by the liquid crystal diffraction element 12 (optically anisotropic layer 26) is separated depending on the turning direction of circularly polarized light, and is diffracted in opposite directions, that is, the arrow X direction and a direction opposite to the arrow X.

Therefore, it is difficult to utilize both of the two separated light diffracted by the liquid crystal diffraction element 12, and only one of the two light can be utilized in many cases. That is, an optical element including a liquid crystal diffraction element in the related art has a low utilization efficiency of the spectrally separated light.

Alternatively, by combining a plurality of optical members such as a mirror and a lens, it is possible to utilize both of the two spectrally separated light diffracted by the liquid crystal diffraction element 12. However, in this case, it is not possible to avoid an increase in size and an increase in complexity of the optical element such as a spectral element.

On the other hand, in the optical element 10 according to the embodiment of the present invention, the two separated light components by the diffraction of the liquid crystal diffraction element 12 are emitted as parallel light from the same surface (third surface) of the prism 14.

That is, in the optical element 10 according to the embodiment of the present invention, the two separated light components by the diffraction of the liquid crystal diffraction element 12 are emitted in the same direction from the same surface (third surface) of the prism 14.

In the optical element 10 according to the embodiment of the present invention, the liquid crystal diffraction element 12 spectrally separates incidence ray. However, as described above, regarding the diffraction of the liquid crystal diffraction element 12, diffraction directions of dextrorotatory circularly polarized light and levorotatory circularly polarized light are opposite to each other, but the diffraction angles are the same as long as the wavelengths are the same.

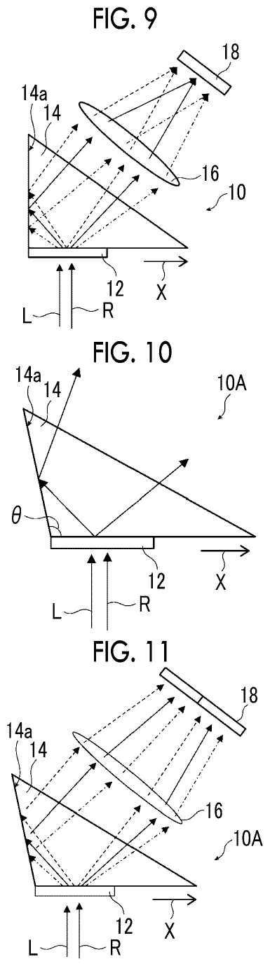

Accordingly, as shown by a solid line, a broken line, and a one-dot chain line in FIG. 9, same as in FIG. 1, one of separated light having the same wavelength is diffracted in the arrow X direction (right direction in the drawing), and the other is specularly reflected from the second surface of the prism 14. As a result, two spectrally separated light diffracted by the liquid crystal diffraction element 12 are converted into parallel light and are emitted from the third surface of the prism 14.

In FIG. 9 (FIG. 11), the broken line represents, for example, blue light; the solid line represents, for example, green light; and the one-dot chain line represents, for example, red light.

Therefore, in the optical element 10 according to the embodiment of the present invention, it is possible to easily utilize two light (diffracted light) separated from each other by the liquid crystal diffraction element 12. As a result, with the optical element 10 according to the embodiment of the present invention, the utilization efficiency of spectrally separated light diffracted by the liquid crystal diffraction element 12 can be improved.

For example, as conceptually shown in FIG. 9, in a case where a lens 16 is disposed to face the third surface of the prism 14 to collect light, the parallel light is collected at the same position, so that two separated light by the liquid crystal diffraction element 12 can be easily measured with one detector 18. That is, with the present invention, the utilization efficiency of spectrally separated light by the liquid crystal diffraction element 12 can be improved.

In addition, as shown in FIG. 9, with the optical element 10 according to the embodiment of the present invention, for example, a simple and compact configuration in which only one lens 16 and one detector 18 are combined with the optical element 10 can constitute a spectroscopic device. That is, with the optical element 10 according to the embodiment of the present invention, it is also possible to achieve reduction in size of the optical system.

In the optical element 10 according to the embodiment of the present invention, the material for forming the prism 14 is not limited, and all of various materials used for various prisms can be used.

Here, in the present invention, it is preferable that a difference in refractive index between the prism 14 and the liquid crystal diffraction element 12 (each layer) is small. Specifically, the difference in refractive index between the prism 14 and the liquid crystal diffraction element 12 is preferably ±0.5 or less and more preferably ±0.3 or less.

With such a configuration, reflection of light between the prism 14 and the liquid crystal diffraction element 12 is prevented, and the utilization efficiency of spectrally separated light by the liquid crystal diffraction element 12 can be further improved.

In the optical element 10 according to the embodiment of the present invention, it is preferable that the second surface 14a of the prism 14, that is, the surface of the prism 14 which reflects one of the separated light by the liquid crystal diffraction element 12 totally reflects the light.

That is, it is preferable that the liquid crystal diffraction element 12 diffracts incidence ray such that one of separated light is incident into the second surface 14a of the prism 14 at an angle equal to or more than a critical angle.

As described above, the diffraction angle of circularly polarized light by the liquid crystal diffraction element 12 is determined by “λ/2” of the single period Λ of the optically anisotropic layer 26 and the wavelength λ of incidence ray.

Accordingly, in the optical element 10 according to the embodiment of the present invention, it is preferable that the single period Λ of the optically anisotropic layer 26 is determined such that the incidence angle of light incident on the second surface 14a of the prism 14 is equal to or more than the critical angle depending on the wavelength of light to be subjected to spectroscopy.

In addition, in a case where the incidence angle of the light incident on the second surface 14a is too large, the size of the prism 14 increases. Accordingly, it is preferable that the single period Λ is determined such that the incidence angle of the light incident on the second surface 14a is not increased and the size of the prism 14 is not increased.

Specifically, in a case where the wavelength λ of light to be subjected to spectroscopy is 450 nm, it is preferable that the single period Λ is 0.3 to 2 μm. In addition, in a case where the wavelength λ of light to be subjected to spectroscopy is 550 nm, it is preferable that the single period Λ is 0.4 to 3 μm. In addition, in a case where the wavelength λ of light to be subjected to spectroscopy is 700 nm, it is preferable that the single period Λ is 0.5 to 4 μm. Furthermore, in a case where the wavelength λ of light to be subjected to spectroscopy is 1,000 nm, it is preferable that the single period Λ is 0.8 to 5 μm.

In the example shown in FIG. 1, the incidence ray is incident into the optical element 10 according to the embodiment of the present invention from the normal direction of the liquid crystal diffraction element 12, but the present invention is not limited thereto.

That is, the incidence of light into the optical element 10 (liquid crystal diffraction element 12) according to the embodiment of the present invention may be from a direction having an angle with respect to the normal direction of the liquid crystal diffraction element 12. Accordingly, in this case, it is preferable to determine the single period Λ of the optically anisotropic layer 26 such that the incidence angle of light on the second surface 14a of the prism 14 is equal to or less than the critical angle, depending on the wavelength of light to be spectrally separated and the incidence angle of the incidence ray to be set.

Alternatively, the incidence angle of light into the optical element 10 (liquid crystal diffraction element 12) according to the embodiment of the present invention may be adjusted such that the incidence angle of light on the second surface 14a of the prism 14 is equal to or less than the critical angle.

In the optical element 10 according to the embodiment of the present invention, the second surface 14a of the prism 14 is not limited to a surface which totally reflects light.

For example, a reflective film such as a dielectric multi-layer film and a metal film may be provided on the second surface 14a of the prism 14 to cause the light to be specularly reflected from the second surface 14a of the prism 14.

However, in consideration of the utilization efficiency of spectrally separated light by the liquid crystal diffraction element 12, it is preferable that one of separated light is incident into the liquid crystal diffraction element 12 at an angle equal to or more than the critical angle such that the light is totally reflected from the second surface 14a of the prism 14.

In the optical element 10 of the illustrated example, as a preferred aspect, in the prism 14, the first surface on which the liquid crystal diffraction element 12 is disposed and the second surface 14a which reflects one of separated light diffracted by the liquid crystal diffraction element 12 are orthogonal to each other. More specifically, in the optical element 10, the main surface of the liquid crystal diffraction element 12 (optically anisotropic layer 26) and the second surface of the prism 14 are orthogonal to each other.

However, in the optical element according to the embodiment of the present invention, various aspects can be used as the angle between the first surface (main surface of the liquid crystal diffraction element 12) and the second surface of the prism 14, in addition to the orthogonality.

In a case where the incidence angle (incidence direction) of light is shifted from the normal direction of the first surface of the prism 14, the same effect, that is, the effect of making one diffracted light from the first surface and light reflected from the second surface 14a parallel to each other can be obtained by shifting the angle between the first surface and the second surface 14a from the orthogonality.

In addition, it is preferable that the one direction (arrow X direction) in which the optical axis rotates in the optically anisotropic layer 26 is parallel to a direction of a diffraction vector of the second surface 14a, that is, a repetition direction of a periodic structure of the diffraction element. In addition, it is preferable that the normal direction of the second surface 14a and the arrow X direction are parallel to each other. In addition, it is preferable that the arrow X direction is included in a plane orthogonal to the first surface and the second surface 14a. Furthermore, it is desirable that a line (ridge line) formed by an angle between the first surface and the second surface 14a of the prism 14 is orthogonal to the arrow X direction.

For example, as in an optical element 10A conceptually shown in FIG. 10, an angle between the first surface and the second surface of the prism 14 may be an obtuse angle.

With such a configuration, as shown in FIG. 10, light diffracted in the arrow X direction (right direction) by the liquid crystal diffraction element 12 and light diffracted in the opposite direction and reflected from the second surface 14a of the prism 14 travel in a direction in which the light are spaced from each other, and are emitted from the third surface.

According to the optical element, as conceptually shown in FIG. 11, the lens 16 is disposed facing the third surface of the prism 14 to collect light, and the light is measured by the detector 18. Therefore, intensity of the light spectrally separated for each of the dextrorotatory circularly polarized light R and the levorotatory circularly polarized light L can be measured by one detector 18.

Alternatively, the angle between the first surface and the second surface of the prism 14 may be an acute angle.

With such a configuration, light diffracted in the arrow X direction (right direction) by the liquid crystal diffraction element 12 and light diffracted in the opposite direction and reflected from the second surface 14a of the prism 14 travel in a direction in which the light are close to each other, and are emitted from the third surface (see FIG. 14).

That is, according to the configuration in which the first surface and the second surface of the prism are not orthogonal to each other, a polarization spectroscopic system which spectrally separates light according to polarization can be configured.

The angle between the first surface (main surface of the liquid crystal diffraction element 12) and the second surface of the prism 14 is preferably 70° to 110°, more preferably 80° to 110°, and still more preferably 90°.

It is preferable that the angle between the first surface and the second surface of the prism 14 is set to 70° to 110°, from the viewpoint that the utilization efficiency of spectrally separated light can be improved more reliably, the spectrally separated light according to the polarization can be detected in a close range, and the like.

In the present invention, basically, the liquid crystal diffraction element 12 is disposed parallel to the first surface of the prism 14. Therefore, the above description is based on the angle between the first surface and the second surface 14a of the prism 14, but the most important matter is the angle between the main surface of the liquid crystal diffraction element 12 (optically anisotropic layer 26) and the second surface 14a.

In addition, in the optical element 10 of the illustrated example, both of the two separated light by the liquid crystal diffraction element 12 are emitted from the third surface of the prism 14.

Accordingly, the angle between the first surface and second surface 14a and the third surface is appropriately set such that light incident on the third surface can be emitted without being reflected.

For example, as shown in FIG. 1, in a case where the first surface on which the liquid crystal diffraction element 12 is provided and the second surface 14a which reflects one of separated light by the liquid crystal diffraction element 12 are orthogonal to each other, the angle between the first surface and the third surface which is an emission surface of the light from the prism 14 is preferably 5° to 60° and more preferably 10° to 45°.

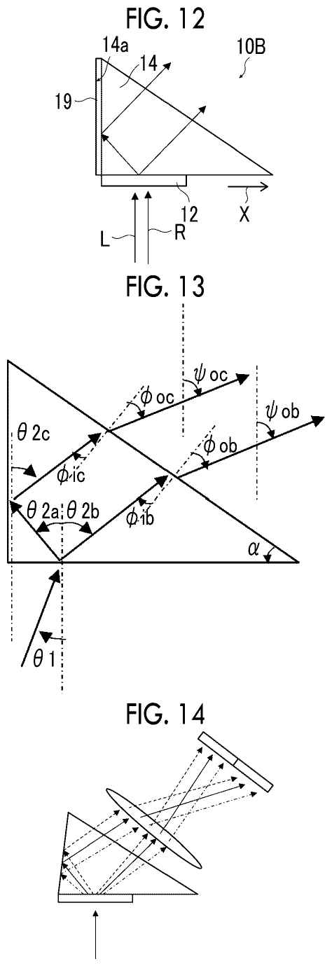

In the present invention, as in an optical element 10B conceptually shown in FIG. 12, a retardation layer 19 may be provided on the surface of the prism 14 which reflects one of separated light by the liquid crystal diffraction element 12, as necessary.

In a case where the prism 14 includes the retardation layer 19, the one of separated light by the liquid crystal diffraction element 12 is reflected after a phase is adjusted by the retardation layer 19.

By providing such a retardation layer 19, for example, phase compensation for a phase changed by total reflection, adjustment of the phase of the spectrally separated light, and for example, making the polarization of one diffracted light from the first surface and the polarization of the light reflected from the second surface 14a of the other diffracted light from the first surface orthogonal or parallel to each other can be performed.

The retardation layer 19 is not limited, and various known retardation layers can be used. In addition, a retardation imparted by the retardation layer 19 is not limited.

In order to prevent reflection at an interface between the prism 14 and the retardation layer 19, it is preferable that the prism 14 and the retardation layer 19 have similar refractive indices. Specifically, a difference in refractive index between the prism 14 and the retardation layer 19 is preferably ±0.5 or less and more preferably ±0.3 or less.

In the optical element 10 of the illustrated example, the prism 14 is a triangular prism, and the light separated by the liquid crystal diffraction element 12 disposed on the first surface is emitted from the third surface different from the first surface and the second surface 14a, in which one of the separated light is emitted directly and the other is reflected by the second surface 14a.

However, the present invention is not limited thereto.

For example, the prism may have a quadrangular or more polygonal shape, and two light may be reflected from one or more surfaces of the prism such that one light separated by the liquid crystal diffraction element 12 is parallel to light reflected from the second surface, and then the two light (diffracted light) may be emitted from a region of the first surface on which the liquid crystal diffraction element 12 is disposed, other than the region where the liquid crystal diffraction element is disposed.

Alternatively, the one light separated by the liquid crystal diffraction element 12 and the light reflected from the second surface may be made parallel to each other, and then the two light may be reflected from one or more surfaces of the prism to emit the two light (diffracted light) from the surface of the prism on which the light is incident for the first time.

That is, in the optical element according to the embodiment of the present invention, in a case where the two light are reflected from the same surface after one light is reflected from the second surface 14a and the two light separated by the liquid crystal diffraction element 12 are made parallel to each other, various configurations can be used for the propagation of light in the prism.

However, in any configuration, it is preferable that the two separated light by the liquid crystal diffraction element 12 are emitted from the same surface of the prism.

Hereinbefore, the optical element according to the embodiment of the present invention has been described in detail, but the present invention is not limited to the above-described examples and various improvements and changes can be made without departing from the spirit of the present invention.

### EXAMPLES

Hereinafter, the characteristics of the present invention will be described in detail by Examples. Materials, chemicals, used amounts, material amounts, ratios, treatment details, treatment procedures, and the like shown in the following examples can be appropriately changed within a range not departing from the scope of the present invention. Therefore, the scope of the present invention should not be construed as being limited to the following specific examples.

### Example 1

### Production of Liquid Crystal Diffraction Element

### (Formation of Alignment Film)

A glass substrate (EAGLE manufactured by Corning Inc.) was prepared as a support. The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

### Alignment Film-Forming Coating Liquid

| | | |
|---|---|---|
| Material for photo alignment shown below | 1.00 | part by mass |
| Water | 16.00 | parts by mass |
| Butoxyethanol | 42.00 | parts by mass |
| Propylene glycol monomethyl ether | 42.00 | parts by mass |

### Material for Photo Alignment

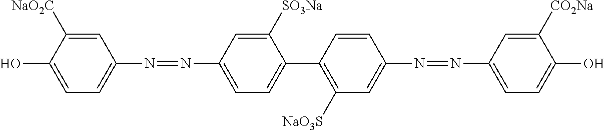

### (Exposure of Alignment Film)

The alignment film was exposed by irradiating the formed alignment film with polarized ultraviolet rays (50 mJ/cm², using a ultra-high pressure mercury lamp).

The alignment film was exposed using the exposure device shown in FIG. 7 to form an alignment film having an alignment pattern. In the exposure device, a laser which emits laser light having a wavelength (325 nm) was used as the laser. An exposure amount of the interference light was set to 300 mJ/cm². An intersecting angle (intersecting angle α) between two laser rays was adjusted such that a single period Λ (length over which the optical axis rotates by) 180° of the alignment pattern formed by interference of the two laser rays was 1 μm.

### (Formation of Optically Anisotropic Layer (Liquid Crystal Layer))

As a liquid crystal composition forming an optically anisotropic layer, the following composition B-1 was prepared.

### Composition B-1

| | | |
|---|---|---|
| Rod-like liquid crystal compound L-1 | 100.00 | parts by mass |
| Polymerization initiator (IRGACURE | 3.00 | parts by mass |
| (registered trade name) 907, | | |
| manufactured by BASFSE) | | |
| Photosensitizer (KAYACURE | 1.00 | part by mass |
| DETX-S manufactured by Nippon | | |
| Kayaku Co., Ltd.) | | |
| Leveling agent T-1 | 0.08 | parts by mass |
| Methyl ethyl ketone | 2000.00 | parts by mass |

Rod-like Liquid Crystal Compound L-1 (including the Following Structures at a Mass Ratio Shown on the Right Side)

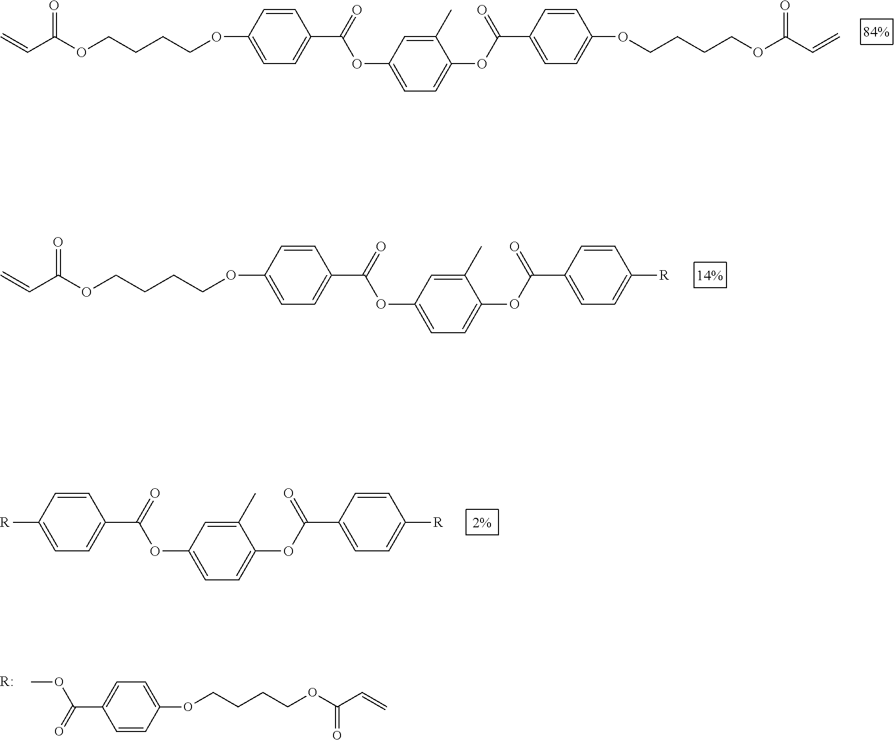

### Leveling Agent T-1

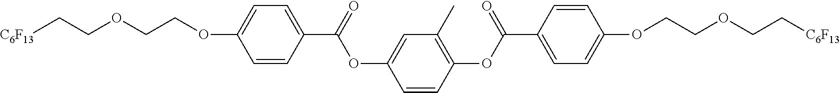

An optically anisotropic layer was formed by applying the composition b-1 to the alignment film in multiple layers.

Specifically, with the composition B-1, a composition of a first layer was applied onto the alignment film, and heated, cooled, and cured with ultraviolet rays to produce a liquid crystal immobilized layer; and then a composition of a second or subsequent layer was applied onto the liquid crystal immobilized layer, and heated, cooled, and cured with ultraviolet rays repeatedly in the same manner as described above.

First, the composition B-1 of a first layer was applied onto the alignment film to form a coating film, and the coating film was heated on a hot plate at 80° C. Next, at 80° C., the coating film was irradiated with ultraviolet rays having a wavelength of 365 nm at an irradiated amount of 300 mJ/cm² using a high-pressure mercury lamp in a nitrogen atmosphere, thereby fixing an alignment of the liquid crystal compound.

Regarding the second or subsequent layer, the composition was applied onto the liquid crystal immobilized layer, and heated, cooled, and cured with ultraviolet rays under the same conditions as described above to produce a liquid crystal immobilized layer. In this way, by repeating the application multiple times until the total thickness reached a desired film thickness, the optically anisotropic layer was formed.

A difference Δn in refractive index of the cured layer of the composition B-1 was obtained by applying the composition B-1 onto a support with an alignment film for retardation measurement, which was prepared separately, aligning a director of the liquid crystal compound to be parallel to a substrate, irradiating the liquid crystal compound with ultraviolet rays for immobilization to obtain a liquid crystal immobilized layer, and measuring a retardation Re(λ) and a film thickness of the liquid crystal immobilized layer. Δn_{λ} can be calculated by dividing the retardation Re(λ) by the film thickness. The retardation Re(λ) was measured at a desired wavelength using Axoscan of Axometrix, and the film thickness was measured using a scanning electron microscope (SEM).

In addition, a refractive index ne(λ) with respect to extraordinary light and a refractive index no(λ) with respect to ordinary light were measured using an Abbe refractometer. In addition, the difference Δn(λ) in refractive index was obtained from the difference between ne(λ) and no(λ). In the notations of Re(λ), ne(λ), no(λ), and Δn(λ), λ is a wavelength of incidence ray. In the following description, the wavelength λ of incidence ray was 633 nm.

It was finally confirmed with a microscope that the optically anisotropic layer had a film thickness of 1.68 μm and Δn₆₃₃×thickness=Re(633) of 255 nm, and periodic alignment was formed. In addition, in the optically anisotropic layer, a twisted angle of the liquid crystal compound in the thickness direction was 0°.

In addition, in the cross-sectional image obtained by SEM, bright and dark lines perpendicular to the lower interface (interface with the support) of the optically anisotropic layer were observed. The bright and dark lines were observed with a configuration in which the liquid crystal compounds aligned in the same orientation were laminated in the thickness direction.

A refractive index of the optically anisotropic layer at a wavelength of 633 nm was ne=1.694 and no =1.543.

The refractive index was measured with an Abbe refractometer.

The formed optically anisotropic layer was transferred and bonded to a bottom surface of a prepared triangular prism.

The triangular prism was made of optical glass of SK2 model number manufactured by SCHOTT, and had a refractive index of 1.605 at a wavelength of 633 nm. The prepared triangular prism was a triangular prism having one angle of 90°. In addition, an angle of an inclined surface (hypotenuse side) of the triangular prism was 20°.

The optically anisotropic layer was bonded to a surface of the triangular prism interposed between the right angle and the angle of 20°. The bonding was performed by direct bonding by a surface treatment for strengthening adhesive strength by plasma treatment.

A bonding direction of the optically anisotropic layer was set to a direction in which the direction of the optical axis of the liquid crystal compound in the optically anisotropic layer changed while rotating, that is, a direction in which the direction of the diffraction vector in a plane of the optically anisotropic layer (direction orthogonal to the bright and dark lines) was orthogonal to the direction of the straight line formed by the right angle of the triangular prism. In this way, an optical element was produced.

### Example 2

In order to form a first optically anisotropic layer in which the liquid crystal compound was right-twisted and aligned in a thickness direction with a helical shape, the following composition B-2 was prepared.

### Composition B-2

| | | |
|---|---|---|
| Rod-like liquid crystal compound L-1 | 100.00 | parts by mass |
| Chiral agent Ch-A | 0.23 | parts by mass |
| Polymerization initiator (IRGACURE | 3.00 | parts by mass |
| (registered trade name) 907, | | |
| manufactured by BASFSE) | | |
| Photosensitizer (KAYACURE | 1.00 | part by mass |
| DETX-S manufactured by Nippon | | |
| Kayaku Co., Ltd.) | | |
| Leveling agent T-1 | 0.08 | parts by mass |
| Methyl ethyl ketone | 2000.00 | parts by mass |

Chiral agent Ch-A

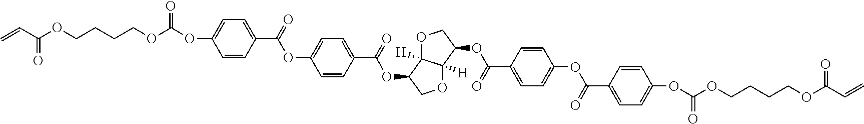 [SMILES: C=CC(=O)OCCCCOC(=O)Oc1ccc(C(=O)Oc2ccc(C(=O)O[C@@H]3CO[C@H]4[C@@H]3OC[C@H]4OC(=O)c3ccc(OC(=O)c4ccc(OC(=O)OCCCCOC(=O)C=C)cc4)cc3)cc2)cc1]

By applying multiple layers of the composition B-2 in the same manner as in Example 1 (composition B-1), a first optically anisotropic layer was formed on the alignment film.

It was finally confirmed with a microscope that the first optically anisotropic layer had a film thickness of 1.68 μm and Δn₆₃₃×thickness=Re(633) of 255 nm, and periodic alignment was formed. In addition, in the first optically anisotropic layer, a twisted angle of the liquid crystal compound in the thickness direction was 70° (right-handed twist).

Furthermore, in the cross-sectional image obtained by SEM, bright and dark lines oblique to the lower interface (interface with the support) of the optically anisotropic layer were observed. The oblique bright and dark lines were observed due to a configuration in which the liquid crystal compound was helically twisted and aligned in the thickness direction.

Next, in order to form a second optically anisotropic layer in which the liquid crystal compound was left-twisted and aligned in a thickness direction with a helical shape, the following composition B-3 was prepared.

### Composition B-3

| | | |
|---|---|---|
| Liquid crystal compound L-1 | 100.00 | parts by mass |
| Chiral agent Ch-B | 0.39 | parts by mass |
| Polymerization initiator (IRGACURE | 3.00 | parts by mass |
| (registered trade name) 907, | | |
| manufactured by BASFSE) | | |
| Photosensitizer (KAYACURE | 1.00 | part by mass |
| DETX-S manufactured by Nippon | | |
| Kayaku Co., Ltd.) | | |
| Leveling agent T-1 | 0.08 | parts by mass |
| Methyl ethyl ketone | 2000.00 | parts by mass |

Chiral agent Ch-B

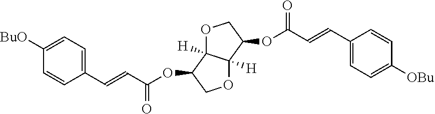

A second optically anisotropic layer was formed on the first optically anisotropic layer by the same method as that of the first optically anisotropic layer, except that the composition B-3 was used.

It was finally confirmed with a microscope that the second optically anisotropic layer had a film thickness of 1.68 μm and Δn₆₃₃×thickness=Re(633) of 255 nm, and periodic alignment was formed. In addition, in the second optically anisotropic layer, a twisted angle of the liquid crystal compound in the thickness direction was −70° (left-handed twist).

Furthermore, in the cross-sectional image obtained by SEM, bright and dark lines oblique to the lower interface (interface with the support) of the optically anisotropic layer were observed. It was observed that orientations of oblique angles between the bright and dark lines of the first optically anisotropic layer and the bright and dark lines of the second liquid crystal were opposite to each other, and a structure of the liquid crystal diffraction element including the left-twisted optically anisotropic layer on the right-twisted optically anisotropic layer was formed.

In this way, a liquid crystal diffraction element in which the first optically anisotropic layer and the second optically anisotropic layer were laminated was produced.

In a case where measurements were performed in the same manner as described above, a refractive index of the first optically anisotropic layer at a wavelength of 633 nm was ne=1.694 and no=1.543, and a refractive index of the second optically anisotropic layer at a wavelength of 633 nm was ne=1.694 and no=1.543.

An optical element was produced using the produced two optically anisotropic layers in the same manner as in Example 1.

### Example 3

As a triangular prism, a triangular prism having vertex angles of 80°, 20°, and 80° was prepared. The triangular prism was made of optical glass of SK2 model number manufactured by SCHOTT, and had a refractive index of 1.605 at a wavelength of 633 nm.

An optical element was produced in the same manner as in Example 1 by replacing the angle of 90° in Example 1 with an angle of 80°, and bonding the optically anisotropic layer produced in Example 2 to ae surface of the triangular prism interposed between the angle of 80° and the angle of 20°.

### Evaluation 1

A spectroscopic system as shown in FIG. 9 was produced using the optical element of Example 1.

As shown in FIG. 13, target light to be spectrally separated was collimated and incident from the surface of the optically anisotropic layer. The incidence light was unpolarized light.

Half of the incidence light was diffracted to the right side in the drawing by the liquid crystal diffraction element; and half of the incidence light was diffracted to the left side in the drawing by the liquid crystal diffraction element and then totally reflected by the second surface of the triangular prism. As a result, the two light separated by the liquid crystal diffraction element were parallel light. Thereafter, the two light were emitted from the inclined surface (hypotenuse side) of the prism. The angles are as shown in the table below.

As shown in FIG. 9, the spectroscopic system is produced so that a signal collected by a condenser lens for each wavelength after the emission surface is captured by a line (image) sensor. As a result of the evaluation, light at 550 nm could be spectrally separated with high efficiency of 95% or more. In addition, light at 400 nm and 700 nm could be spectrally separated with high efficiency of 50% or more, and light at 1,000 nm could be spectrally separated with high efficiency of 20% or more.

TABLE 1

| Wavelength | θ1 | θ2a | θ2b | θ2c | α | φib | φic | φob | φoc | φob | φoc |
|---|---|---|---|---|---|---|---|---|---|---|---|
| [nm] | [°] | | | | [deg] | [deg] | | | | | |
| 400 | 0 | −14.2 | 14.2 | 14.2 | 20 | −5.7 | −5.7 | −9.3 | −9.3 | 10.6 | 10.6 |
| 550 | | −20 | 20 | 20 | | 0 | 0 | 0 | 0 | 20 | 20 |
| 700 | | −25.9 | 25.9 | 25.9 | | 5.9 | 5.9 | 9.5 | 9.5 | 29.5 | 29.5 |
| 1000 | | −38.8 | 38.8 | 38.8 | | 18.8 | 18.8 | 31 | 31 | 51 | 51 |

### Evaluation 2

A spectroscopic system was produced using the optical element of Example 3 in the same manner as in Evaluation 1.

The angle of light was the same as in Evaluation 1 using the optical element of Example 1.

In addition, light at 550 nm could be spectrally separated with high efficiency of 95% or more. In addition, light at 400 nm and 700 nm could be spectrally separated with high efficiency of 90% or more, and light at 1,000 nm could be spectrally separated with high efficiency of 70% or more.

That is, by using the optically anisotropic layer which was helically twisted and aligned in the thickness direction and laminating the optically anisotropic layers having opposite helical twisted directions, the diffraction efficiency higher than that in Example described above could be obtained, and the efficiency of spectroscopy could be improved.

### Evaluation 3

A spectroscopic system was produced using the optical element of Example 3 in the same manner as in Evaluation 1.

The angle of light was as shown in Table 2 below.

In addition, the efficiency was the same as in Evaluation 2 using the optical element of Example 2, having the same liquid crystal diffraction element.

It was found that, in the optical element of Example 3 using a prism in which the angle between the first surface and the second surface was 80°, the angles of φob and the angles of φoc did not overlap each other, different from the optical elements of Examples 1 and 2 using a triangular prism in which the first surface (bonding surface of the liquid crystal diffraction element) and the second surface (reflecting surface) were orthogonal to each other. That is, in this example, as shown in FIG. 14, ±1st order light split into left and right by the diffraction element, that is, two diffracted light split into different directions depending on the polarization could be collected at separate focal positions. That is, it was found that the optical element of Example 3 functioned as a polarization spectroscopic system that can perform spectroscopy depending on polarization.

TABLE 2

| Wavelength | θ1 | θ2a | θ2b | θ2c | α | φib | φic | φob | φoc | φob | φoc |
|---|---|---|---|---|---|---|---|---|---|---|---|
| [nm] | [°] | | | | [deg] | [deg] | | | | | |
| 400 | 0 | −14.2 | 14.2 | 34.2 | 20 | −5.7 | 14.2 | −9.3 | 23.6 | 10.6 | 43.6 |
| 550 | | −20 | 20 | 40 | | 0 | 20 | 0 | 33.4 | 20 | 53.4 |
| 700 | | −25.9 | 25.9 | 45.9 | | 5.9 | 25.9 | 9.5 | 44.4 | 29.5 | 64.4 |

From the above results, the effect of the present invention is clear.

The optical element according to the embodiment of the present invention can be suitably used for various optical elements such as a spectral element.

### EXPLANATION OF REFERENCES

10, 10A, 10B: optical element
12: liquid crystal diffraction element
14: prism
16: lens
18: detector
20: support
24: alignment film
26: optically anisotropic layer
30: liquid crystal compound
30A: optical axis
60: exposure device
62: laser
64: light source
68: beam splitter
70A, 70B: mirror
72A, 72B: λ/4 plate
M: laser light
MA, MB: ray
MP: P polarized light
MS: S polarized light
P₀: linearly polarized light
R: dextrorotatory circularly polarized light
L: levorotatory circularly polarized light
Q, Q1, Q2: absolute phase
E, E1, E2: equiphase plane

What is claimed is:

1. An optical element comprising:
a liquid crystal diffraction element; and
a prism having a first surface which is in direct contact with the liquid crystal diffraction element or is in contact with the liquid crystal diffraction element through another layer,
wherein the liquid crystal diffraction element includes an optically anisotropic layer having a liquid crystal alignment pattern in which an orientation of an optical axis derived from a liquid crystal compound changes while continuously rotating in at least one in-plane direction, and
the prism has a second surface which reflects one of separated light by diffraction of the liquid crystal diffraction element.

2. The optical element according to claim 1,
wherein, in the optically anisotropic layer, the liquid crystal compound is helically twisted and aligned along a thickness direction.

3. The optical element according to claim 2,
wherein the liquid crystal diffraction element includes at least two optically anisotropic layers in which the liquid crystal compound is helically twisted and aligned along a thickness direction, and
twisted directions of the liquid crystal compound in two of the optically anisotropic layers are opposite to each other in the thickness direction.

4. The optical element according to claim 1,
wherein an angle between the first surface and the second surface of the prism is 70° to 110°.

5. The optical element according to claim 1,
wherein light separated by the diffraction of the liquid crystal diffraction element and reflected by the second surface and light which is not incident into the second surface are emitted from the same surface of the prism.

6. The optical element according to claim 1,
wherein the liquid crystal diffraction element includes at least two optically anisotropic layers in which the liquid crystal compound is helically twisted and aligned along a thickness direction, and
twisted directions of the liquid crystal compound in two of the optically anisotropic layers are opposite to each other in the thickness direction.

7. The optical element according to claim 2,
wherein an angle between the first surface and the second surface of the prism is 70° to 110°.

8. The optical element according to claim 2,
wherein light separated by the diffraction of the liquid crystal diffraction element and reflected by the second surface and light which is not incident into the second surface are emitted from the same surface of the prism.

9. The optical element according to claim 3,
wherein an angle between the first surface and the second surface of the prism is 70° to 110°.

10. The optical element according to claim 3,
wherein light separated by the diffraction of the liquid crystal diffraction element and reflected by the second surface and light which is not incident into the second surface are emitted from the same surface of the prism.

11. The optical element according to claim 4,
wherein light separated by the diffraction of the liquid crystal diffraction element and reflected by the second surface and light which is not incident into the second surface are emitted from the same surface of the prism.
